(19) United States
(12) Patent Application Publication
(10) Pub. No.: US 2025/0056344 A1
(43) Pub. Date: Feb. 13, 2025

(54) UE SWITCHING PROCESS WITH SUSPENSION AND SUBSEQUENT RESUMPTION FOLLOWING A HANDOVER FAILURE

(71) Applicant: SHARP KABUSHIKI KAISHA, Sakai City, Osaka (JP)

(72) Inventors: Kenneth James Park, Vancouver, WA (US); EDWARD MASAMI SUGIYAMA, Vancouver, WA (US)

(21) Appl. No.: 18/720,655

(22) PCT Filed: Nov. 18, 2022
(86) PCT No.: PCT/JP2022/042804

§ 371 Date: Jun. 16, 2024

Related U.S. Application Data
(60) Provisional application No. 63/291,930, filed on Dec. 20, 2021.

(51) Int. Cl. H04W 36/00; H04W 76/27

(52) U.S. Cl. CPC H04W 36/0079; H04W 76/27

(57) ABSTRACT

A method for a user equipment (UE) is provided. The method includes the UE maintaining a Radio Resource Control (RRC) connection with a first base station (BS) of a first network while receiving transmissions from a second BS of a second network during at least one time period specified in a switch gap configuration. The UE receives an RRC reconfiguration message from the first BS that includes a first command and a second command. The first command instructs the UE to begin a handover procedure from the first BS to a third BS. The second command controls usage of the switch gap configuration by the UE following a failure of the handover procedure. The UE initiates the handover procedure according to the first command. The UE may suspend reception of transmissions from the second BS following reestablishment of the RRC connection after the handover failure based on the second command.

### TECHNICAL FIELD

The present disclosure generally relates to wireless communications and more specifically relates to suspending and subsequently resuming a switching process following a failure of a handover procedure of a user equipment (UE) between two or more base stations (e.g., Next Generation NodeBs (gNBs)) of a wireless network (e.g., a fifth generation (5G) (e.g., New Radio (NR)) network).

### BACKGROUND ART

As employed on a mobile telephony device (e.g., mobile phone, satellite phone, smart watch, computer, camera, and so on), a Subscriber Identity Module (SIM) card is an integrated circuit running a Card Operating System (COS) that is intended to securely store the International Mobile Subscriber Identity (IMSI) number and its related encryption key for the device. This number and key are used to identify and authenticate the associated subscriber of a mobile communication network supporting the device.

A Universal Subscriber Identity Module (USIM) is the functional equivalent of a SIM in that it stores subscriber-related information. Additionally, a USIM operates as a miniature computer that may handle several miniature applications, such as the implementation of enhanced security functions pertaining to user authentication and data ciphering on the user side in mobile telephony devices.

In some cases, a mobile telephony device, which may be more generally referred to as a user equipment (UE), may be a multiple-USIM (Multi-USIM or MUSIM) device. In the consumer market, some commercially deployed UEs support a configuration with more than one USIM (e.g., typically two USIMs), each of which may be associated with the same or a different network. Support for a MUSIM device is conventionally handled in an implementation-specific manner without any support from 3rd Generation Partnership Project (3GPP) specifications, resulting in a variety of implementations. An implementation-specific MUSIM device typically uses common radio and baseband components that are shared among the multiple USIMs and under the control of a single processor, which may lead to issues that negatively impact 3GPP system performance.

For example, while actively communicating with a first network associated with a first USIM (USIM-A), the UE may occasionally check a second network associated with a second USIM (USIM-B) (e.g., to monitor the paging channel, detect a Synchronization Signal Block (SSB), perform signal measurements, or read system information) and decide, for example, if the UE should respond to a paging request from the other system. This occasional activity on the second network may or may not have any performance impact, depending on the UE implementation.

Paging Occasions (POs) are typically calculated based on the UE identifier (e.g., IMSI and 5G Serving Temporary Mobile Subscriber Identity (5G-S-TMSI) for Evolved Packet System (EPS) and 5G System (5GS), respectively). In some cases, the UE identifier values associated with the different USIMs may lead to systematic collisions that may result in missed pages (e.g., a page on the first network associated with USIM-A occurs at, or nearly at, the same time as a page on the second network associated with USIM-B).

Further, when the UE receives a page on the second network, the UE may be configured to decide whether to respond to the page (e.g., by following user-configured rules). In the absence of information indicating the service type that has triggered the paging (e.g., voice or data service), the UE may have to blindly decide whether to ignore or respond to the page.

Thereafter, in cases in which the UE decides to respond to the page in the second network, or when the UE is required to perform some signaling activity (e.g., Periodic Mobility Registration Update) in the second network, the UE may be required to stop its current activity in the first network. In the absence of any procedure for suspension of the ongoing activity, the UE may autonomously release the Radio Resource Control (RRC) connection with the first network and abruptly leave the network. Such release is likely to be interpreted by the first network as an error case, which may distort connection statistics in the first network and thus misguide algorithms that rely on the statistics. Moreover, during the UE's absence, the first network may keep paging the UE, which may result in wasting paging resources.

Currently, the 3GPP is addressing the functionality of a Multi-USIM device as the functionality pertains to the coordinated operation of the device in and with a 3GPP network. As such functionality may impact the physical layer, radio protocol, and radio architecture enhancements, as well as Service and System Aspects (SAs), the issue is being addressed in the 3GPP Technical Specification Group (TSG) SA Working Group 1 (WG1) (referred to as SA1), 3GPP TSG SA WG2 (SA2), and 3GPP TSG RAN WG2 (RAN2) working groups.

As a result of this work, in some proposals, a UE may be configured to switch its communication resources from a first network to a second network (referred to as “network switching” or more simply “switching”) to facilitate MUSIM functionality. When switching from a first network to a second network, the UE may tune its receiver/transmitter away from the time and frequency resources associated with the first network to the time and frequency resources associated with the second network. Switching functionality may be enabled by a configuration of the UE, where the UE may access the time and frequency resources of the first network as associated with a first USIM and the time and frequency resources of the second network as associated with a second USIM of the UE in a time-division-multiplexed (TDM) manner.

Currently, two kinds of switching procedures have been proposed. According to the first procedure, the UE may tune away from a gNB of the first network to a gNB of the second network for short periods of time. Such periods are known by the UE and by the gNB of the first network to be sufficiently short such that the UE may tune, receive, and decode paging occasions and other network type information from the gNB of the second network and then retune back to the gNB of the first network within such a period of time that the gNB of the first network does not experience Radio Link Failure (RLF) and/or Beam Failure Detection (BFD) with the UE. The network type information may include, for example, System Information (SI) receiving, Synchronization Signal Block (SSB) detection, serving cell and neighboring cell signal measurement (e.g., intra-frequency, inter-frequency, and inter-radio-access-technology(inter-RAT)measurement). Such switching is referred to as “Switching Without Leaving RRC_CONNECTED”, or simply “Switching Without Leaving”.

According to the second switching procedure, the UE may tune away from the gNB of the first network to use time and frequency resources of the gNB of the second network for periods of time that are sufficiently long and continuous in duration that the UE cannot maintain a connection to the gNB of the first network without the gNB of the first network experiencing RLF and/or BFD. Thus, the UE must leave the RRC_CONNECTED state associated with the gNB of the first network before switching to the gNB of the second network. Such switching is known as “Switching with Leaving RRC_CONNECTED”, or simply “Switching with Leaving”.

For the case of Switching Without Leaving, the UE may know the duration and periodicity of paging occasions and other network type information events that occur with the gNB of the second network. Thus, to assist the UE in receiving the periodic network type information from the gNB of the second network, the UE may request the gNB of the first network to not schedule any uplink (UL) or downlink (DL) time and frequency resources during one or more periods of time when the UE intends to receive/transmit information on the gNB of the second network. The term “gap” is used to define such a period of time when the gNB of the first network does not schedule any UL or DL time and frequency resources for the UE. Accordingly, the aforementioned period of time allows the UE to omit interactions (e.g., receiving/transmitting data) with the gNB of the first network. The gap may delimit a period of time during which the UE may be busy receiving and/or transmitting data from/to a gNB of another cell and/or network. For the purposes of this disclosure, a gap in the UL or DL time and frequency resources of a gNB of a first network may be scheduled to provide the UE with the opportunity to switch from the gNB of the first network to a gNB of the second network for a scheduled period of time that aligns with transmissions of network information of the second network and/or transmissions of UE information to the second network. In some examples, a gap may be scheduled by a gNB of a network to reoccur at a fixed periodicity.

As proposed in greater detail below, a gap schedule between the UE and a first gNB of the first network may be subsequently employed between the UE and the first gNB during a handover procedure of the UE from the first gNB to a second gNB, as well as after a failure of the handover procedure (e.g., when the UE reattaches to the first gNB of the first network), thus possibly facilitating an efficient use of the time and frequency resources at least through the failed handover process. However, employing the gap schedule immediately after a failure of the handover process may interfere with the transfer of data between the first gNB of the first network and the UE that was not previously transmitted, and thus is buffered or queued at the network or the UE, during the attempted execution of the handover procedure. This interference may significantly exacerbate data transfer latency that typically results from a handover process while attempting to efficiently employ the use of Switching Without Leaving after the handover failure.

### SUMMARY OF INVENTION

In one example, a user equipment (UE), comprising: one or more non-transitory computer-readable media having computer-executable instructions embodied thereon; and at least one processor coupled to the one or more non-transitory computer-readable media and configured to execute the computer-executable instructions to: while maintaining a Radio Resource Control (RRC) connection with a first base station (BS) of a first network, receive transmissions from a second BS of a second network during at least one time period specified in a switch gap configuration; receive a first RRC reconfiguration message from the first BS, the first RRC reconfiguration message comprising a first command and a second command, the first command instructing the UE to begin a handover procedure from the first BS to a third BS, and the second command controlling usage of the switch gap configuration by the UE following a failure of the handover procedure; initiate execution of the handover procedure from the first BS to the third BS according to the first command; determine, after initiating the execution of the handover procedure, that the handover procedure has failed; reestablish, after determining that the handover procedure has failed, the RRC connection with the first BS; and when the second command suspends continued usage of the switch gap configuration following the failure of the handover procedure, suspend reception of transmissions from the second BS following reestablishing of the RRC connection with the first BS.

In one example, a first base station (BS) of a first network, the first BS comprising: one or more non-transitory computer-readable media having computer-executable instructions embodied thereon; and at least one processor coupled to the one or more non-transitory computer-readable media and configured to execute the computer-executable instructions to: maintain a Radio Resource Control (RRC) connection with a user equipment (UE) while facilitating gaps in communication with the UE according to a switch gap configuration to facilitate reception of transmissions by the UE from a second BS of a second network; and transmit, to the UE, an RRC reconfiguration message comprising a first command and a second command, the first command instructing the UE to begin a handover procedure from the first BS to a third BS, and the second command comprising a value indicating whether usage of the switch gap configuration by the UE is to be suspended following a failure of the handover procedure.

In one example, a first base station (BS), the first BS comprising: one or more non-transitory computer-readable media having computer-executable instructions embodied thereon; and at least one processor coupled to the one or more non-transitory computer-readable media and configured to execute the computer-executable instructions to: receive, from a second BS of a first network, a handover request message for a user equipment (UE), the handover request message comprising a first command indicating whether usage of a switch gap configuration by the UE is to be suspended following a failure of a handover procedure, the switch gap configuration specifying at least one time period during which the UE receives transmissions from a third BS of a second network; generate an RRC reconfiguration message comprising the first command and a second command, the second command instructing the UE to begin a handover procedure from the second BS to the first BS; and transmit, to the second BS, a handover request acknowledgment message comprising the RRC reconfiguration message.

### BRIEF DESCRIPTION OF DRAWINGS

Implementations of the present technology will now be described, by way of example only, with reference to the attached figures.

FIG. 1 illustrates a block diagram of a MUSIM UE in communication with gNBs of two different networks, according to an example implementation of the present disclosure.

FIG. 2A illustrate a signaling diagram for suspending the usage of a switch gap configuration after a failure of a handover procedure between gNBs, according to an example implementation of the present disclosure.

FIG. 2B illustrate a signaling diagram for suspending the usage of a switch gap configuration after a failure of a handover procedure between gNBs, according to an example implementation of the present disclosure.

FIG. 3A illustrate a signaling diagram for not suspending the usage of a switch gap configuration after a failure of a handover procedure between gNBs, according to an example implementation of the present disclosure.

FIG. 3B illustrate a signaling diagram for not suspending the usage of a switch gap configuration after a failure of a handover procedure between gNBs, according to an example implementation of the present disclosure.

FIG. 4A illustrate a flow diagram of a method performed by a UE to facilitate a suspension of a switching procedure after a failure of a handover procedure, according to an example implementation of the present disclosure.

FIG. 4B illustrate a flow diagram of a method performed by a UE to facilitate a suspension of a switching procedure after a failure of a handover procedure, according to an example implementation of the present disclosure.

FIG. 5A illustrate a flow diagram of a method performed by a source gNB to facilitate a suspension of a switching procedure after a failure of a handover procedure, according to an example implementation of the present disclosure.

FIG. 5B illustrate a flow diagram of a method performed by a source gNB to facilitate a suspension of a switching procedure after a failure of a handover procedure, according to an example implementation of the present disclosure.

FIG. 6 illustrates a flow diagram of a method performed by a target gNB to facilitate a suspension of a switching procedure after a failure of a handover procedure, according to an example implementation of the present disclosure.

FIG. 7 illustrates an example of a new Other Configuration (otherConfig) information element (IE), according to an example implementation of the present disclosure.

FIG. 8A illustrate an example of a new RRC Reconfiguration (RRCReconfiguration) IE, according to an example implementation of the present disclosure.

FIG. 8B illustrate an example of a new RRC Reconfiguration (RRCReconfiguration) IE, according to an example implementation of the present disclosure.

### DESCRIPTION OF EMBODIMENTS

The 3GPP is a collaboration agreement that aims to define globally applicable technical specifications and technical reports for third and fourth generation wireless communication systems. The 3GPP may also define specifications for next generation mobile networks, systems, and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A) and other standards (e.g., 3GPP Releases 8, 9, 10, 11, 12, 13, 14, 15, and so on) including New Radio (NR) which is also known as 5G. However, the scope of the present disclosure should not be limited in this regard. At least some aspects of the systems and methods disclosed herein may be utilized in other types of wireless communication systems.

A wireless communication device may be an electronic device used to communicate voice and/or data to a base station (BS), which in turn may communicate with a network of devices (e.g., public switched telephone network (PSTN), the Internet, etc.). In describing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices may include cellular phones, smart phones, personal digital assistants (PDAs), laptop computers, netbooks, e-readers, wireless modems, etc.

In the 3GPP specifications, a wireless communication device may typically be referred to as a UE. However, as the scope of the present disclosure should not be limited to the 3GPP standards, the terms “UE” and “wireless communication device” may be used interchangeably herein to mean the more general term “wireless communication device.” A UE may also be more generally referred to as a terminal device.

In the 3GPP specifications, a BS is typically referred to as a NodeB, an evolved NodeB (eNB), a home enhanced or evolved NodeB (HeNB), a Next Generation NodeB (gNB) or some other similar terminology. As the scope of the disclosure should not be limited to 3GPP standards, the terms “base station,” “NodeB,” “eNB,” “HeNB,” and “gNB” may be used interchangeably herein to mean the more general term “base station.” Furthermore, the term “base station” or “BS” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An eNB and/or gNB may also be more generally referred to as a base station device.

It should be noted that as used herein, a “cell” may be any communication channel that is specified by standardization or regulatory bodies to be used for International Mobile Telecommunications-Advanced (IMT-Advanced) and all of it or a subset of it may be adopted by 3GPP as licensed bands (e.g., frequency bands) to be used for communication between an eNB and a UE. It should also be noted that in the E-UTRA and E-UTRAN overall description, as used herein, a “cell” may be defined as a “combination of downlink and optionally uplink resources.” The linking between the carrier frequency of the downlink resources and the carrier frequency of the uplink resources may be indicated in the system information transmitted on the downlink resources.

“Configured cells” are those cells of which the UE is aware and is allowed by an eNB and/or gNB to transmit or receive information. “Configured cell(s)” may be serving cell(s). The UE may receive system information and perform the required measurements on all configured cells. “Configured cell(s)” for a radio connection may include a primary cell and/or no, one, or more secondary cell(s).

“Activated cells” are those configured cells on which the UE is transmitting and receiving. That is, activated cells are those cells for which the UE monitors the physical downlink control channel (PDCCH) and, in the case of a downlink transmission, those cells for which the UE decodes a physical downlink shared channel (PDSCH). “Deactivated cells” are those configured cells for which the UE is not monitoring the transmission of PDCCH. It should be noted that a “cell” may be described in terms of differing dimensions. For example, a “cell” may have temporal, spatial (e.g., geographical), and frequency characteristics.

The 5G communication systems, dubbed NR technologies by the 3GPP, envision the use of time/frequency/space resources to allow for services, such as Enhanced Mobile Broadband (eMBB) transmission, Ultra-Reliable Low-Latency Communications (URLLC) transmission, and massive Machine Type Communication (mMTC) transmission. Also, in NR, single-beam and/or multi-beam operations are considered for downlink and/or uplink transmissions.

Various examples of the systems and methods disclosed herein are now described with reference to the figures, where like reference numbers may indicate functionally similar elements. The systems and methods as generally described and illustrated in the figures herein could be arranged and designed in a wide variety of different implementations. Therefore, the detailed description of the present disclosure as illustrated in the figures is not intended to limit scope of the present disclosure but is merely representative of the systems and methods.

According to various implementations of the present disclosure, a mechanism is discussed by which a “gap configuration” (or, as also used below, a “switch gap configuration”) specifying one or more gaps scheduled between a UE and a first gNB of a first network, as described above, may continue to be employed during an attempted handover operation, as well as after a failure of such operation. More specifically, a switch gap configuration may include data specifying one or more time periods, or “gaps”, during which the gNB of the first network does not schedule any UL or DL time and frequency resources for the UE. Accordingly, the aforementioned periods of time may allow the UE to omit interactions (e.g., receiving and/or transmitting of data) with the gNB of the first network (e.g., such that the UE may employ those time periods to “switch” to a gNB of a second network, for example, to receive paging and other information). Such implementations may thus facilitate use of the gaps by the UE during the handover operation and/or after its failure, thus retaining the efficiency associated with the Switching Without Leaving procedure during that time.

However, under some circumstances, allowing such switching after the failure of a handover operation may negatively impact data transfer latency in the short term. For example, a significant amount of data may have been buffered by the UE and/or the first gNB of the first network during the handover attempt (e.g., while the UE was not connected to either the first gNB or the second gNB). Consequently, in some implementations described below, to facilitate an efficient transfer of the buffered data after a failure of the handover operation, the switching operations may be suspended for some period of time to increase the number of UL or DL frequency and time resources provided by the first gNB immediately after the failure of the handover operation.

The term “handover” may herein refer to a procedure performed jointly by a UE and a wireless network to switch/change at least one serving cell serving the UE to another cell during a connected state (e.g., RRC_CONNECTED state). The at least one serving cell may include, but is not limited to, a primary cell (PCell), a secondary cell (SCell), a primary secondary cell (PSCell), or a combination thereof. Such a serving cell may be a part/member of a master cell group (MCG) or a secondary cell group (SCG).

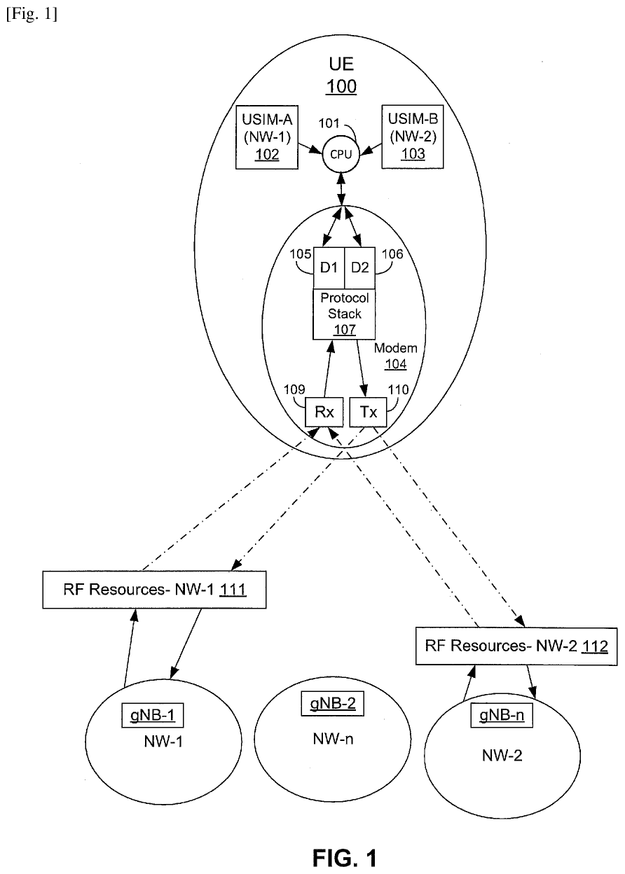

FIG. 1 illustrates a block diagram of a MUSIM UE 100 (or, simply, the UE) in communication with gNBs of two different networks, according to an example implementation of the present disclosure. As depicted in FIG. 1, the UE may include a first USIM 102 (USIM-A) to identify the UE with a first network NW-1 (or, alternately, NW-A), as well as a second USIM 103 (USIM-B) to identify the UE with a second network NW-2 (or, alternately, NW-B). Further, first network NW-1 may include a first gNB (gNB-1), and second network NW-2 may include another gNB (gNB-n). In other implementations, a greater number of gNBs may be included in either or both of first network NW-1 and second network NW-2. In addition, a separate network NW-n with which the UE is not in communication may include a second gNB (gNB-2). In the examples provided below, switching of the UE may occur between gNB-1 of network NW-1 and gNB-n of network NW-2, at which point a handover operation of the UE may be attempted from gNB-1 of network NW-1 (e.g., operating as a source gNB) to gNB-2 of network NW-n (e.g., operating as a target gNB). While network NW-n is shown as a separate network from networks NW-1 and NW-2, in other examples, network NW-n may be the same as network NW-1 or network NW-2. In other words, the target gNB (gNB-2) may be in any network with which the UE is capable of communicating.

In further reference to FIG. 1, the UE may also include at least one central processing unit (CPU) 100 or other processor that is communicatively coupled to USIM-A and USIM-B to facilitate communication with first network NW-1 and second network NW-2, respectively, by way of a modulator/demodulator (modem) unit 104. Modem 104 may include at least one transmitter (Tx) 110 and at least one receiver (Rx) 109 for communicating with first network NW-1 and second network NW-2 over radio frequency (RF) resources (e.g., time and frequency resources) corresponding to each network NW-1 and NW-2 (e.g., RF resources 111 and 112). Modem 104 may also include a communication protocol stack 107 in communication with transmitter Tx 110 and receiver Rx 109, as well as two data processing regions D1 105 and D2 106 associated with first network NW-1 and second network NW-2, respectively. The UE may also include memory that is coupled to the at least one processor 101 and that stores instructions that are executable by the at least one processor 101 to perform various operations of the UE discussed herein. Other portions of the UE (e.g., a touchscreen, a microphone, a speaker, and so on that may receive or present data associated with data processing regions D1 and D2) are not explicitly depicted in FIG. 1.

To facilitate discussion in portions of the description below, first gNB-1 of first network NW-1 (as shown in FIG. 1) is referred to as gNB-1_NW-1 (or as the source gNB), second gNB-2 of network NW-n is referred to as gNB-2_NW-n (or as the target gNB), and gNB-n of second network NW-2 is referred to as gNB-n_NW-2. In some implementations, each gNB may include at least one transmitter, at least one receiver, at least one processor, and memory that is coupled to the at least one processor and that stores instructions that are executable by the at least one processor to perform various operations of the gNB, as discussed herein.

In some implementations, the UE may accomplish a request for one or more gaps by sending gNB-1_NW-1 a Gap Configuration Assistance Information Message via an IE (e.g., a new IE called switchGapConfig). The transmission of the switchGapConfig IE to gNB-1_NW-1 may be provided by UL-DCCH-Message::UEAssistanceInformation. In some implementations, the format of switchGapConfig may be derived from an existing IE (e.g., the measGapConfig IE, as described in Technical Specification (TS) 38.331), such as by employing various parameters sufficient to identify and request one or more time intervals or periods during which UL and DL time and frequency resources for the UE are not to be scheduled by a gNB (e.g., gNB-1_NW-1, for the purpose of paging, receiving system information, and so on with gNB-n_NW-2).

In some implementations, the gaps requested in a Gap Configuration Assistance Information Message may be any of three types: “Periodic Gap”, “A-periodic Gap”, and “Autonomous Gap”. A Periodic Gap may provide for a repeating period of time (e.g., establishing a pattern) where a gNB does not schedule any UL or DL time and frequency resources for the UE. An A-periodic Gap may provide for a single period of time where a gNB does not schedule any UL or DL time and frequency resources for the UE. An Autonomous Gap may indicate that the network does not configure gaps for the UE. The Gap Configuration Assistance Information Message may include multiple gap requests (e.g., two different Periodic gap patterns, or one Periodic gap pattern and one a-periodic gap, or other combinations).

In some implementations, the information provided by the UE to a gNB of first network NW-1 about a switching gap configuration via the Gap Configuration Assistance Information Message may include information about the starting time of the gap (e.g., expressed as an offset value or start System Frame Number (SFN), and a subframe), the gap length, and the gap repetition period. However, as the timing of the transmission of network resources between different networks may not be the same, the UE may map the timing information of the gap relative to a gNB of second network NW-2 (e.g., gNB-n_NW-2) onto the timing of the gNB of first network NW-1 (e.g., gNB-1_NW-1). Accordingly, the request to gNB-1_NW-1 may be in the form of mapped timing values of gNB-n_NW-2.

As a result of the Gap Configuration Assistance Information Message provided by the UE to gNB-1_NW-1, in some implementations, gNB-1_NW-1 may in turn provide the UE with a Gap Configuration Assistance Information Response Message (e.g., via the switchGapConfig IE, as described above). The switchGapConfig IE may include one or more switch gap configurations for the switching process. The transmission of the switchGapConfig IE to the UE may be provided by DL-DCCH::RRCReconfiguration.OtherConfig. The one or more switch gap configurations provided in a Gap Configuration Assistance Information Response Message may include any of the three types discussed above: Periodic Gap, A-periodic Gap, and/or Autonomous Gap. The Gap Configuration Assistance Information Response Message may include one or more gap results. For example, the one or more switch gap configurations may define one or more gaps (e.g., periodic, a-periodic, and/or autonomous gaps) where gNB-1_NW-1 will not assign the UE any UL/DL time and frequency resources, and thus the UE may tune away from gNB-1_NW-1 during those gaps to receive information from gNB-n_NW-2 and not miss receiving DL data or miss transmitting UL data with gNB-1_NW-1. In some implementations, the gaps may be synchronized to the NR/LTE frame structure.

As a result, if the UE is actively Switching Without Leaving gNB-1_NW-1 to receive paging and other signaling on gNB-n_NW-2, then the gaps in the gNB-1_NW-1 gap schedule of transmission/reception resources may enable the UE to switch to gNB-n_NW-2 without missing scheduled transmission/reception resources of gNB-1_NW-1. The gap schedules may be based upon the one or more switch gap configurations that were previously agreed to by both the UE and gNB-1_NW-1.

In some situations, however, if the UE is handed over from gNB-1_NW-1 to a second gNB (e.g., gNB-2_NW-n) and the UE is actively Switching Without Leaving gNB-1_NW-1 to receive paging and other system information via gNB-n_NW-2, then upon reception of a command by the UE to engage in a handover operation (e.g., via an RRCReconfiguration message) from gNB-1_NW-1 to gNB-2_NW-n, the UE may be compelled to terminate the switching procedure between gNB-1_NW-1 and gNB-n_NW-2 and restart the switching procedure anew with gNB-2_NW-n to create gaps in the transmission and/or reception resources scheduled for the UE by gNB-2_NW-n following the handover. For example, such gaps may be employed to provide the UE with opportunities to Switch Without Leaving gNB-2_NW-n (e.g., to receive paging and other information via gNB-n_NW-2).

However, in some cases, the handover of the UE from gNB-1_NW-1 to gNB-2_NW-n may fail, thus causing the UE to reattach or reconnect with gNB-1_NW-1. Consequently, the UE may be able to employ the previous switch gap configurations provided by gNB-1_NW-1 prior to the attempted handover, thus potentially facilitating an expedited reestablishment of the switching procedure of the UE to gNB-n_NW-2.

Consequently, as mentioned above, a failure of the handover process may cause both the UE and the network to experience a first time period during which DL data from the network and UL data from the UE cannot be transmitted. In some examples, the first time period may begin with the termination of the connection of the UE to the source gNB (gNB-1_NW-1) and ending with the reconnection of the UE to the source gNB. UL data that is not transmitted by the UE during this first time period of the handover process may be queued at the UE until the connection between the UE and gNB-1_NW-1 is reestablished, and resources are made available for the transmission of data. Additionally, DL data that is not transmitted by gNB-1_NW-1 during this first time period of the handover process may be queued at gNB-1_NW-1 and subsequently forwarded to the UE when the connection between the UE and gNB-1_NW-1 is reestablished, and resources are made available for the transmission of data.

Consequently, immediately following failure of the handover process of the UE from gNB-1_NW-1 to gNB-2_NW-n and a connection between the UE and gNB-1_NW-1 is reestablished, and resources are made available for transmission of data between the UE and gNB-1_NW-1, a second time period may be identified during which the data queued for transmission (at the UE and gNB-1_NW-1) and the switching gaps (e.g., previously configured by gNB-1_NW-1 or another gNB of NW-1 for the UE) may by employed by the UE to periodically monitor gNB-n_NW-2. As a consequence, resources that could be used for the transmission of queued data are instead reserved as switching gaps for the UE. Thus, the continuation of the switching procedure may lead to inefficient allocation of resources by gNB-1_NW-1 and undesirable switching behavior by the UE if no action is taken by gNB-1_NW-1 to modify the pre-agreed behavior of the UE that allows the UE to switch to gNB-n_NW-2 during gap periods that may occur during this second time period.

An example of a scenario leading to such inefficient resource allocation by gNB-1_NW-1 and undesirable behavior by the UE may occur if the data queued for transmission during the handover process has a higher priority than the switching gaps. In such a scenario, the higher priority queued data should be transmitted immediately during the second time period using all available resources. Accordingly, if gNB-1_NW-1 does not coordinate with the UE prior to the second time period to prevent the continued usage of pre-agreed switching gaps by the UE during the second time period, gNB-1_NW-1 may be forced to continue a reserve allocation of Tx/Rx resources for lower priority switching gaps while allocating the remaining Tx/Rx resources to clear the higher priority data queues.

For the remainder of this disclosure, the terms “suspension interval”, “time interval”, and/or “interval” may refer to a period of time following a failure of a handover process of a UE from a source gNB (e.g., gNB-1_NW-1) to a target gNB (e.g., gNB-2_NW-n). In some implementations, the interval may start with the reestablishment of a connection between the UE and the source gNB such that resources are made available for the transmission of data between the UE and the source gNB, and the interval may end when the data queued at the UE and the source gNB are cleared or estimated to be cleared. During that interval, the scheduling of Tx/Rx resources by the source gNB for the UE that could be used for the transmission of data queued at the UE and source gNB may overlap the resources reserved for switching gaps (e.g., previously configured by the source gNB for the UE).

Also, for the remainder of this disclosure, while the abbreviation “gNB” is employed to identify the 5G NodeB base station, this reference may also apply to a Next Generation Evolved Node-B (eNB) base station. Also, within this disclosure, the terms “terminal”, “device”, “User Equipment”, and “UE” may be used interchangeably.

Additionally, for the remainder of this disclosure, a Multi-USIM (MUSIM) device may be presumed to be configured with a USIM-A associated with first network NW-1 (or NW-A) and a USIM-B associated with second network NW-2 (or NW-B), as illustrated in FIG. 1. However, in practice, USIM-A and USIM-B may be associated with the same network but treated by the network as independent devices with independent subscriptions. Moreover, a MUSIM application or feature of the UE may be one that interacts with the multiple USIMs on the UE. In some implementations, a processor resident in the UE (as indicated in FIG. 1) may control a “switching procedure” of the UE, as described in greater detail herein.

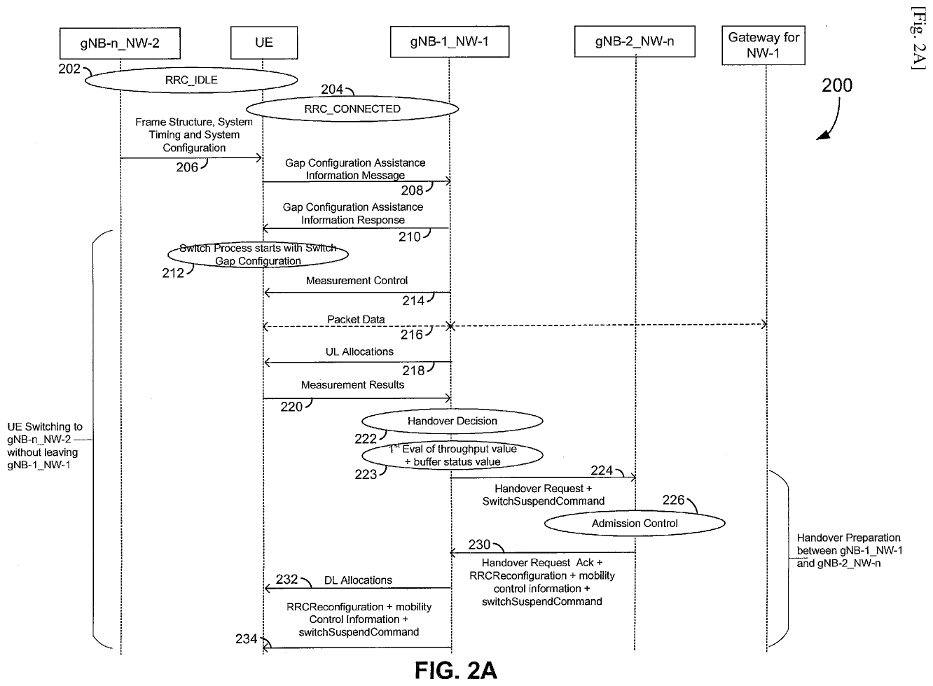

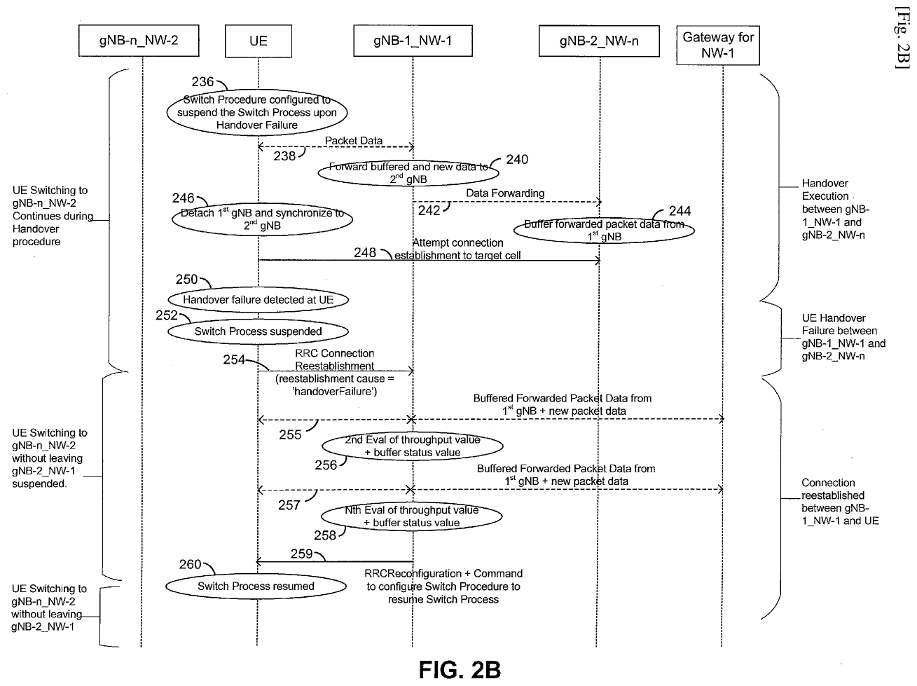

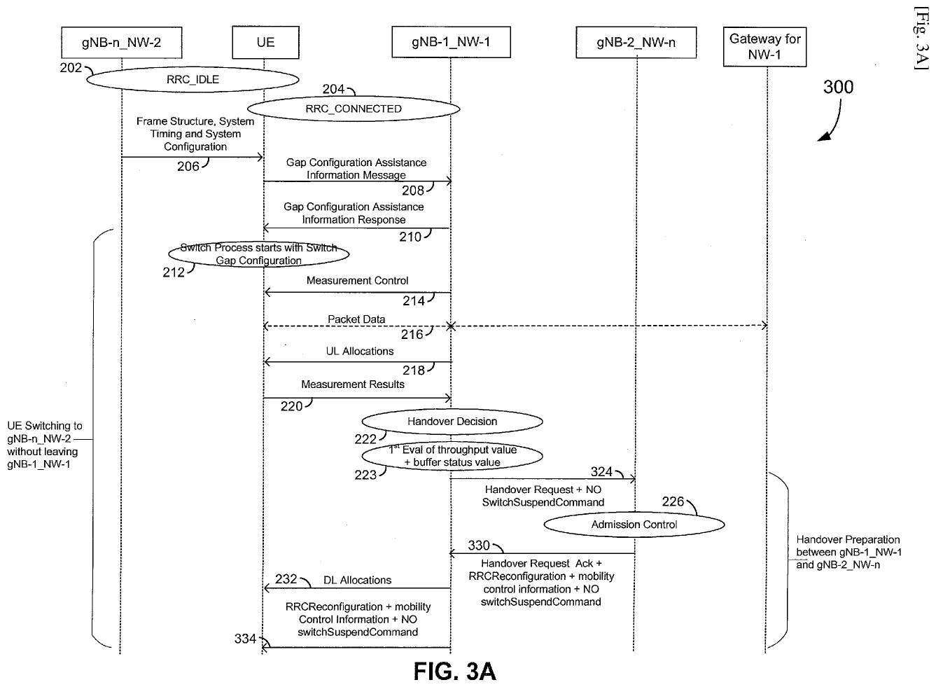

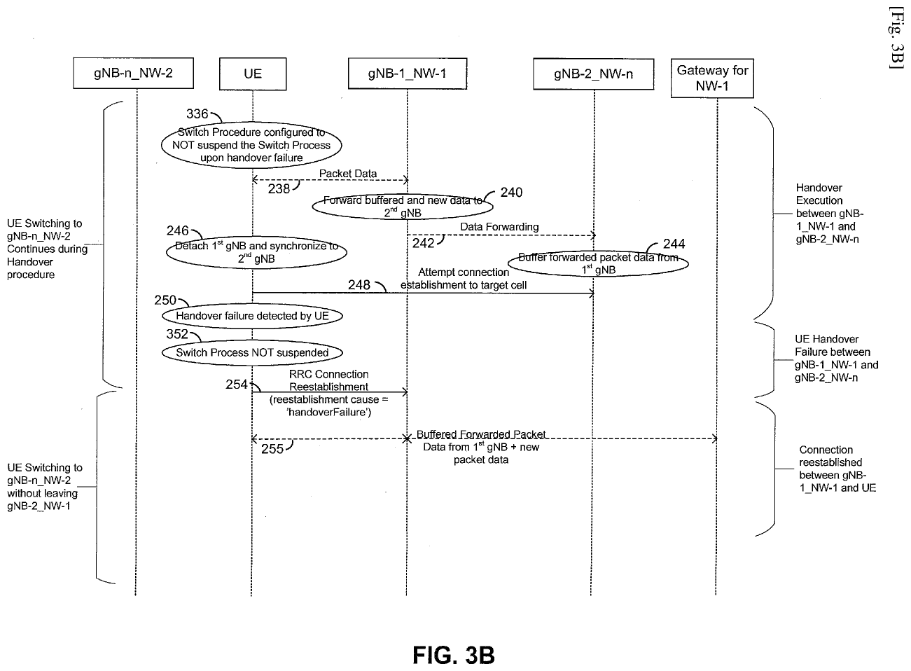

FIGS. 2A and 2B illustrate a signaling diagram 200 for suspending the usage of a switch gap configuration after a failure of a handover procedure between gNBs, according to an example implementation of the present disclosure. Conversely, FIGS. 3A and 3B illustrate a signaling diagram 300 for not suspending the usage of a switch gap configuration after a failure of a handover procedure between gNBs, according to an example implementation of the present disclosure. As seen in FIGS. 2A and 3A, a first portion of communications among the UE, gNB-1_NW-1, gNB-2_NW-n, a gateway for first network NW-1, and gNB-n_NW-2 at least up until an evaluation by gNB-1_NW-1 as to whether use of a switch gap configuration should be paused or suspended are substantially similar between signaling diagrams 200 and 300.

For example, a switching procedure may be provided to enable the UE to switch between (1) the use of UL/DL time and frequency resources, as scheduled by a gNB of first network NW-1 (e.g., gNB-1_NW-1) that is associated with a first USIM (USIM-A) of the UE and (2) the use of UL/DL time and frequency resources, as scheduled by a gNB of second network NW-2 (e.g., gNB-n_NW-2) that is associated with a second USIM (USIM-B) of the UE while not disregarding or “missing” any time and frequency resources scheduled to the UE by gNB-1_NW-1.

In some implementations, the switching procedure may include a method for the acquisition of configuration data from gNB-1_NW-1 by way of the UE requesting such data (e.g., by sending a Gap Configuration Assistance Information message to gNB-1_NW-1), where the configuration data may be employed to control the operation of the switching procedure. The configuration data may include one or more switch gap configurations. In some implementations, the one or more switch gap configurations may identify periods of time where gNB-1_NW-1 will not schedule UL or DL time and frequency resources for the UE. Such periods of time may be used by the switching procedure to determine opportunities when the UE can network-switch from gNB-1_NW-1 to gNB-n_NW-2 for the purpose of using time and frequency resources of gNB-n_NW-2 while not missing or disregarding any scheduled time and frequency resources of gNB-1_NW-1. The duration and periodicity of the timing periods of the one or more switch gap configurations, having been proposed by the UE to the gNB-1_NW-1, for example, via the Gap Configuration Assistance Information message, may be either accepted or rejected by gNB-1_NW-1.

In some implementations, as indicated in FIGS. 2A and 3A, the UE may reside in an RRC_IDLE state 202 with gNB-n_NW-2 and in an RRC_CONNECTED state 204 with gNB-1_NW-1. The proposed timing periods for gap switching may be based on the acquisition of information by the UE about the frame structure, system timing, and system configuration of gNB-n_NW-2 at operation 206. Further, in some implementations, the frame structure, system timing, and system configuration information may be based on the reception, by the UE, of the Primary Synchronization Signal (PSS) and the Secondary Synchronization Signal (SSS), and the Master Information Block (MIB), System Information Block 1 (SIB1), and System Information Block 2 (SIB2) messages broadcast by gNB-n_NW-2. The timing periods may represent occasions where gNB-n_NW-2 may schedule time and frequency resources for the UE to receive at least pages from gNB-n_NW-2.

Accordingly, in some implementations, the UE may create at least one Gap Configuration Assistance Information Message that identifies the timing periods during which the UE may desire to receive pages, SIB update information, and/or other broadcast information from gNB-n_NW-2. Further, in some implementations, the UE may transmit the Gap Configuration Assistance Information Message to gNB-1_NW-1 at operation 208 via UL-DCCH-Message.UEAssistanceInformation.switchGapConfig. The gNB-1_NW-1 may respond to the Gap Configuration Assistance Information Message by transmitting to the UE at least one switch gap configuration message, for example, in a Gap Configuration Assistance Information Response message at operation 210 (e.g., via DL-DCCH::RRCReconfiguration.OtherConfig.switchGapConfig).

In some implementations, the switching procedure may begin using the one or more switch gap configurations to determine opportunities during which the UE can Switch Without Leaving gNB-1_NW-1 to receive paging and other information from gNB-n_NW-2 at operation 212. The switching procedure may be enabled to use the one or more switch gap configurations upon receipt of the RRCReconfiguration.OtherConfig message that included the switchGapConfig IE.

The switch gap configurations that are actively in use by the switching procedure to determine opportunities when the UE can Switch Without Leaving a first network to a second network (e.g., first network NW-1 to second network NW-2) may be referred to as the “currently-jointly-in-use” one or more switch gap configurations, which indicates that a gNB is actively using the one or more switch gap configurations to create gaps in the UL/DL time and frequency resources scheduled to a UE, and the switching procedure is actively using the same one or more switch gap configurations to determine opportunities when the UE can Switch Without Leaving first network NW-1 to second network NW-2.

In various implementations described herein, as depicted in signaling diagrams 200 and 300 of FIGS. 2A and 3A, respectively, a method of operating the UE, gNB-1_NW-1, and gNB-2-NW-1 may enable the switching procedure of the UE to operate concurrently with a handover procedure of the UE, such that during the procedure to handover the UE from gNB-1_NW-1 to gNB-2_NW-n, the UE may continue to switch to gNB-n_NW-2. More specifically, the method may enable the continued operation of the switching procedure during and after a failed handover procedure of the UE, as based on the one or more switch gap configurations currently in use by the UE and the source gNB of the handover (e.g., gNB-1_NW-1).

In some implementations, gNB-1_NW-1 may render a handover decision (Handover Decision at operation 222 in FIGS. 2A and 3A) based on signal measurement results transmitted from the UE to gNB-1_NW-1 at operation 220. In some implementations, the measurement results provided by the UE may be based on measurement control commands provided by gNB-1_NW-1 at operation 214, where the results may be transmitted using UL resources allocated by gNB-1_NW-1 at operation 218. These operations may continue while packet data is transferred between the UE and a gateway for network NW-1 via gNB-1_NW-1 at operation 216.

In association with the handover decision at operation 222, gNB-1_NW-1 may perform an evaluation at operation 223 (FIGS. 2A and 3A) to determine whether the use of gap switching, as described above, should be paused or suspended for some suspension interval after a potential failure of the handover command. In some implementations, this information may include, but not limited to, one or more of a value indicating the UL/DL data throughput (e.g., average, maximum, or the like) between the UE and gNB-1_NW-1, a value indicating an amount of DL data intended for the UE that is buffered (e.g., currently buffered) at gNB-1_NW-1, and/or a value indicating an amount of UL data intended for gNB-1_NW-1 that is buffered (e.g., currently buffered) at the UE. Other information, values, and/or criteria to facilitate a decision by gNB-1_NW-1 as to whether use of the switch gap configurations may be employed after a handover failure may also be included in conjunction with the handover request in other implementations.

In some implementations, the evaluation performed by gNB-1_NW-1 at operation 223 may result in an estimation of the amount of data that may be queued at the UE and at by gNB-1_NW-1 upon the connection reestablishment of the UE with the source gNB (gNB-1_NW-1) that may follow an unsuccessful handover of the UE from the source gNB to the target gNB (gNB-2_NW-n).

In some implementations, the evaluation may result in an estimation of the amount of UL/DL resources needed to clear the data estimated to be queued or buffered at the UE and at gNB-1_NW-1 upon the connection reestablishment of the UE with gNB-1_NW-1 that will follow an unsuccessful handover of the UE.

In some implementations, the evaluation may result in an estimated time period (e.g., a time period value (e.g., a timer value) referred to herein as a switchSuspendlntervalValue) that may be required to transmit the data estimated to be queued at the UE and the data estimated to be queued at gNB-1_NW-1. The estimated time period may be based on the estimated UL/DL resources needed to clear all of the data estimated to be queued at the UE and gNB-1_NW-1 upon reestablishment of the connection of the UE with gNB-1_NW-1 following the unsuccessful handover procedure.

Further, in some implementations, gNB-1_NW-1 may compare the estimated time period (e.g., switchSuspendlntervalValue) to a threshold. Additionally, gNB-1_NW-1 may compare the priority of transmitting queued data to the priority of providing the switching gaps. In some implementations, when the estimated time period exceeds the threshold, and/or the transmission of queued data has a higher priority than providing the switching gaps, gNB-1_NW-1 may generate a switchSuspendCommand (e.g., an enumerated value, such as a named or labeled value), where the switchSuspendCommand may be set to a Suspend value. In some implementations, when the switchSuspendCommand is set to Suspend, the switching process of the UE may be configured to suspend the switching process (e.g., indefinitely until subsequently resumed) following the successful reestablishment of the connection of the UE with gNB-1_NW-1 after the failed handover procedure of the UE from gNB-1_NW-1 to gNB-2_NW-n.

If, instead, where the estimated time period (e.g., switchSuspendlntervalValue) does not exceed the threshold, and/or the transmission of queued data is of lower priority than providing the switching gaps, gNB-1_NW-1 may generate a switchSuspendCommand indicating no suspension is needed (e.g., where the switchSuspendCommand is set to a Resume value). In such examples, where the switchSuspendCommand is set to Resume, or alternatively, the switchSuspendCommand is not generated, the UE may be directed not to suspend the switching process following the reestablishment of the connection of the UE with gNB-1_NW-1 after a failed handover procedure of the UE from gNB-1_NW-1 to gNB-2_NW-n.

Overall, in some implementations, the process by which gNB-1_NW-1 may determine whether to cause the UE to temporarily suspend gap switching operations may include a number of operations:
(1) An estimation of the amount of DL data queued at gNB-1_NW-1 and an estimation of the amount of UL data queued at UE following the reestablishment of the connection of the UE with gNB-1_NW-1 after the failed handover.

(2) An estimation of the amount of UL/DL resources needed by gNB-1_NW-1 to clear the data estimated to be queued at the UE and at gNB-1_NW-1 after connection reestablishment.

(3) An estimation of a time period (e.g., a suspension interval, or switchSuspendlntervalValue) required to transmit all of the DL data queued at the gNB and all of the UL data queued at the UE.

(4) A comparison of the priority of the transmission of queued data to the priority of providing the switching gaps.

(5) A generation of a switchSuspendCommand (e.g., having an enumerated value of Suspend) to be employed by the UE to suspend the gap switching process of the UE (e.g., indefinitely until subsequently resumed) if the estimated time period exceeds a threshold and/or the priority of transmission of queued data exceeds the priority of the gap switching process.

In some implementations, gNB-1_NW-1 and gNB-2_NW-n may communicate via an Xn/NG interface to transmit configuration and control data. Further, in some implementations, the transmission of configuration data and control data from gNB-1_NW-1 to gNB-2_NW-n via the Xn/NG interface in preparation for (e.g., prior to) a handover may utilize a handover request message (e.g., more specifically, the HANDOVER-REQUEST Message of TS 36.413). More particularly, the HANDOVER-REQUEST Message may be used for the passing of the Source-To-Target-Transparent-Container (e.g., see TS 29.280), which may be used for passing an RRC-Container, which may contain information necessary for preparing gNB-2_NW-n to accept the handover.

In some embodiments, the Source-To-Target-Transparent-Container included in the handover request message may contain a switchSuspendCommand (at operation 224 of FIG. 2A) that may be generated by gNB-1_NW-1, as discussed above, possibly in addition to other configuration and control data. In some embodiments, gNB-1_NW-1 may send a copy of the switchSuspendCommand in the HANDOVER-REQUEST Message to indicate that gNB-2_NW-n is to include the switchSuspendCommand in an RRCReconfiguration message to be subsequently transmitted by gNB-2_NW-n back to gNB-1_NW-1 (e.g., via a HANDOVER-REQUEST-ACKNOWLEDGE message, as described below). In such implementations, the RRCReconfiguration message may (1) trigger a handover procedure in the UE and (2) reconfigure the UE as part of the handover procedure, where the handover procedure includes gNB-2_NW-n as the target gNB and gNB-1_NW-1 as the source gNB of the handover.

Presuming, instead, that a switchSuspendCommand with a Resume value is generated at gNB-1_NW-1, or in the alternative, no switchSuspendCommand is generated at gNB-1_NW-1 (e.g., indicating that the gap switching process is not to be suspended or paused after connection reestablishment of the UE with gNB-1_NW-1 following a failure of the handover procedure), gNB-1_NW-1 may generate a handover request message that either does not include a switchSuspendCommand or includes a switchSuspendCommand with a Resume value and transfer the handover request message to gNB-2-_NW-n (e.g., at operation 324 of FIG. 3A).

In some implementations, in response to receiving the handover request, gNB-2_NW-n may perform admission control at operation 226 of FIGS. 2A and 3A to reserve resources to facilitate communication with the UE.

Presuming a switchSuspendCommand (e.g., indicating that the gap switching process is to be suspended or paused after completion of the handover procedure) is received at gNB-2_NW-n as a result of operation 224 of FIG. 2A, gNB-2_NW-n may generate a message indicating the switchSuspendCommand. In some implementations, the switchSuspendCommand command may be included in an RRCReconfiguration message. In such implementations, the RRCReconfiguration message may (1) trigger a handover procedure in the UE, (2) reconfigure the UE as part of the handover procedure, where the handover procedure includes gNB-2_NW-n as the target gNB and gNB-1_NW-1 as the source gNB of the handover, and (3) configure the switching procedure of the UE to suspend the operations of the associated switching process following the failure of the handover and the subsequent reattachment of the UE to the source gNB.

Presuming, instead, that a switchSuspendCommand with a Resume value (e.g., indicating that the gap switching process is not to be suspended or paused after completion of the handover procedure) is received by gNB-2-_NW-n, or no switchSuspendCommand is received by gNB-2-_NW-n, as a result of operation 324 of FIG. 3A, gNB-2_NW-n may include a switchSuspendCommand command with a Resume value in an RRCReconfiguration message. In the alternative, the lack of a switchSuspendCommand included in an RRCReconfiguration message may indicate that the switching process is not to be suspended or paused. In such implementations, the RRCReconfiguration message may (1) trigger a handover procedure in the UE, (2) reconfigure the UE as part of the handover procedure, where the handover procedure includes gNB-2_NW-n as the target gNB and gNB-1_NW-1 as the source gNB of the handover, and (3) configure the switching procedure of the UE to continue the operations of the associated switching process following the failure of the handover and the subsequent reattachment of the UE to the source gNB.

In some implementations, gNB-2_NW-n may send the generated RRCReconfiguration message (e.g., possibly including the switchSuspendCommand to configure the switching procedure of the UE) to gNB-1_NW-1 at operation 230 of FIG. 2A (e.g., if the switchSuspendCommand is set to Suspend) or at operation 330 of FIG. 3A (e.g., if the switchSuspendCommand is set to Resume, or is not included in the RRCReconfiguration message). In some implementations, gNB-1_NW-1 and gNB-2_NW-n may communicate the RRCReconfiguration message via the Xn/NG interface to transmit configuration and control data. Further, in some implementations, the transmission of configuration and control data from gNB-1_NW-1 to gNB-2_NW-n via the Xn/NG interface in preparation for (e.g., prior to) a handover may use a handover request acknowledgment message (e.g., the HANDOVER-REQUEST-ACKNOWLEDGE Message of TS 38.413 and/or TS 38.423). In some implementations, the HANDOVER-REQUEST-ACKNOWLEDGE message may be sent in response to a HANDOVER-REQUEST message. In some implementations, the HANDOVER-REQUEST-ACKNOWLEDGE Message may be used for the passing of the Target-To-Source-Transparent-Container (e.g., see TS 29.280), which may be used for passing an RRC-Container, which may contain an RRCReconfiguration message (e.g., the RRCReconfiguration message prepared by the target gNB of the handover, gNB-2_NW-n, and delivered to the UE by the source gNB of the handover, gNB-1_NW-1). In turn, in some implementations, the RRCReconfiguration message may carry an otherConfig IE (described in greater detail below), which may carry the command that configures the switching process of the UE, possibly including the switchSuspendCommand. In some examples, gNB-2_NW-n may add mobility control information to the communication sent to gNB-1_NW-1.

In response to receiving the RRCReconfiguration message, gNB-1_NW-1 may allocate DL resources to the UE to provide information to the UE regarding the handover and the gap switching process at operation 232 of FIGS. 2A and 3A. Also, in some implementations, gNB-1_NW-1 may forward, to the UE, the RRCReconfiguration message that was received from gNB-2_NW-n. In some implementations, the RRCReconfiguration message may include a command (e.g., a command carried in the otherConfig IE, such as the switchSuspendCommand) that configures the switching procedure of the UE. More specifically, the RRCReconfiguration message may include a switchSuspendCommand (e.g., set to a Suspend value) to suspend the switching process at the UE after connection reestablishment of the UE with gNB-1_NW-1 after failure of the handover process (at operation 234 of FIG. 2A) or may include a switchSuspendCommand (e.g., set to a Resume value) or may not include a switchSuspendCommand (at operation 334 of FIG. 3A). In some implementations, gNB-1_NW-1 may use the PDSCH physical channel to transmit data to the UE. Moreover, in some implementations, the PDSCH physical channel may use the Downlink Shared Channel (DL-SCH) transport channel, and the DL-SCH transport channel may use the Dedicated Control Channel (DCCH) logical channel. Also, in some implementations, the DCCH logical channel may carry the RRCReconfiguration message that includes a command that configures the switching procedure of the UE, and possibly the mobility control information received from gNB-2_NW-n.

Now referring to FIGS. 2B and 3B, after the UE receives the RRCReconfiguration message from gNB-1_NW-1, the UE may configure its gap switching procedure based on the message. In some implementations, in response to receiving an RRCReconfiguration message with a switchSuspendCommand (e.g., with a Suspend value) at operation 234 of FIG. 2A, the UE may configure its switching procedure to pause or suspend the switching process after reestablishment of the connection of the UE with gNB-1_NW-1 following a failure of the handover procedure (at operation 236 of FIG. 2B). In response to receiving an RRCReconfiguration message with a switchSuspendCommand (e.g., with a Resume value) or without a switchSuspendCommandcommand at operation 334 of FIG. 3A, the UE may instead configure its switching procedure to not pause or suspend the switching process after reestablishment of the connection of the UE with gNB-1_NW-1 following a failure of the handover procedure (at operation 336 of FIG. 3B).

During the handover procedure, as depicted in FIGS. 2B and 3B, the UE may continue the switching procedure, as indicated by the one or more switch gap configurations. Also, during the handover procedure, packet data may be transferred until the UE disconnects from gNB-1_NW-1, after which gNB-1_NW-1 may forward currently buffered data and newly received data destined for the UE to gNB-2_NW-n at operations 240 and 242, where the data may be temporarily buffered at operation 244. During these forwarding and buffering operations, the UE may be disconnecting from gNB-1_NW-1 and synchronizing itself with the signal timing of gNB-2_NW-n at operation 246. The UE may then attempt to establish a connection with gNB-2_NW-n at operation 248.

In the event that the handover procedure fails, as detected by the UE at operation 250 of FIGS. 2B and 3B, then based on the switch procedure configuration performed by the UE (at operation 236 of FIG. 2B or operation 336 of FIG. 3B), as described above, the UE may either suspend the switching procedure at operation 252 of FIG. 2B (e.g., as determined by a switchSuspendCommand with a Suspend value) or allow the switching procedure that was executed through the handover procedure to continue without pause at operation 352 of FIG. 3B (e.g., as determined by a switchSuspendCommand command with a Resume value, or the absence of a switchSuspendCommand). In addition, the UE may transmit an RRC Connection Reestablishment message (e.g., including a parameter for the reestablishment cause as being set to handoverFailure) to gNB-1_NW-1 at operation 254, signifying failure of the handover procedure and requesting reconnection with gNB-1_NW-1.

Further, in FIGS. 2B and 3B, after the connection between the UE and gNB-1_NW-1 is reestablished subsequent to the failure of the handover, gNB-1_NW-1 may begin forwarding previously buffered data as well as newly arrived data to the UE, and the UE may begin forwarding data buffered at the UE to gNB-1_NW-1, at operation 255. In FIG. 3B, the buffered data may be forwarded at operation 255 while switching operations of the UE between gNB-1_NW-1 and gNB-n_NW-2 proceed as a result of the switching process not being suspended at operation 352.

Conversely, in FIG. 2B, while the switching process of the UE is suspended as a result of operation 252, and the previously buffered data is being forwarded, gNB-1_NW-1 may perform (e.g., repeatedly and/or repetitively) one or more evaluations of current (e.g., updated and/or estimated) values of information regarding at least one of the UL/DL data throughput between the UE and gNB-1_NW-1, the remaining amount of DL data buffered at gNB-1_NW-1, or the remaining amount of UL data buffered at the UE, among other values/criteria (e.g., at operations 256 and 258). In some implementations, the evaluation may result in an estimation of the amount of UL/DL resources needed to clear the remaining data estimated to be queued or buffered at the UE and at gNB-1_NW-1.

In some implementations, the evaluation may result in an estimated remaining time period (e.g., switchSuspendlntervalValue, which may be a timer value) that may be required to transmit the remaining data estimated to be queued at the UE and the remaining data estimated to be queued at gNB-1_NW-1, for example, based on the estimated UL/DL resources needed to clear all of the data estimated to be queued at the UE and the data estimated to be queued at gNB-1_NW-1.

Further, in some implementations, gNB-1_NW-1 may compare the estimated remaining time period (e.g., switchSuspendIntervalValue) to a threshold. In some implementations, when the estimated time period falls below the threshold, gNB-1_NW-1 may generate a switchSuspendCommand (e.g., an enumerated value) at operation 259 of FIG. 2B, where the switchSuspendCommand may be set to a Resume value. In some implementations, gNB-1_NW-1 may use the RRCReconfiguration message to transport the SwitchSuspendCommand to the UE via the otherConfig IE (e.g., as described above). Alternately, gNB-1_NW-1 may use a Media Access Control (MAC) Control Element (CE) (MAC-CE) to transport the SwitchSuspendCommand to the UE (e.g., where the command to resume the switching process may be a single-bit field in the MAC-CE message).

In some implementations, if, instead, the estimated remaining time period exceeds the threshold, gNB-1_NW-1 may continue to perform (e.g., repetitively or repeatedly) the evaluation (e.g., as discussed above) in light of the updated (e.g., estimated) value data throughput and buffered data amounts while the buffered data is being forwarded to the UE and gNB-1_NW-1 until the estimated remaining time period falls below the threshold, at which point gNB-1_NW-1 may generate a switchSuspendCommand (e.g., an enumerated value) at operation 259, where the switchSuspendCommand may be set to a Resume value, as described above.

In some implementations, when the UE receives a switchSuspendCommand set to Resume, the UE may be configured to resume the previously suspended switching process at operation 260 (e.g., upon receipt of the switchSuspendCommand by the UE).

In some implementations, the process by which gNB-1_NW-1 may determine whether to cause the UE to resume the previously suspended gap switching operations may include one or more of the following operations:

(1) An estimation of the amount of UL/DL resources needed by gNB-1_NW-1 to clear the remaining data queued at the UE and at gNB-1_NW-1.

(2) An estimation of a remaining time period (e.g., switchSuspendlntervalValue) required to transmit all of the remaining DL data queued at gNB-1_NW-1 and all of the remaining UL data queued at the UE.

(3) A generation of a switchSuspendCommand (e.g., with an enumerated value of Resume) to be employed by the UE to resume a previously suspended gap switching process of the UE, for example, when the estimated time period falls below a threshold.

(4) A repetition of these operations until either gNB-1_NW-1 transmits a switchSuspendCommand (e.g., with an enumerated value of Resume) or a timeout occurs.

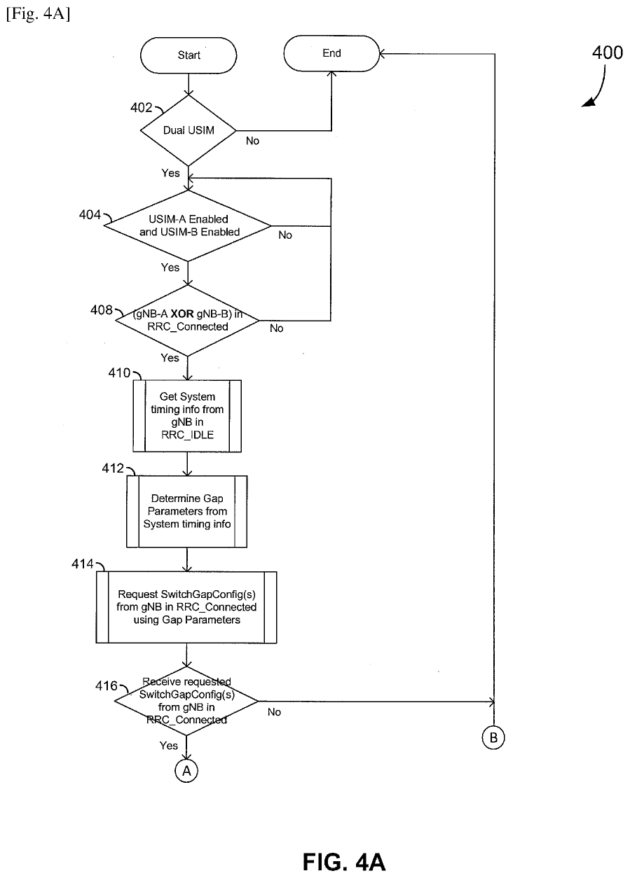

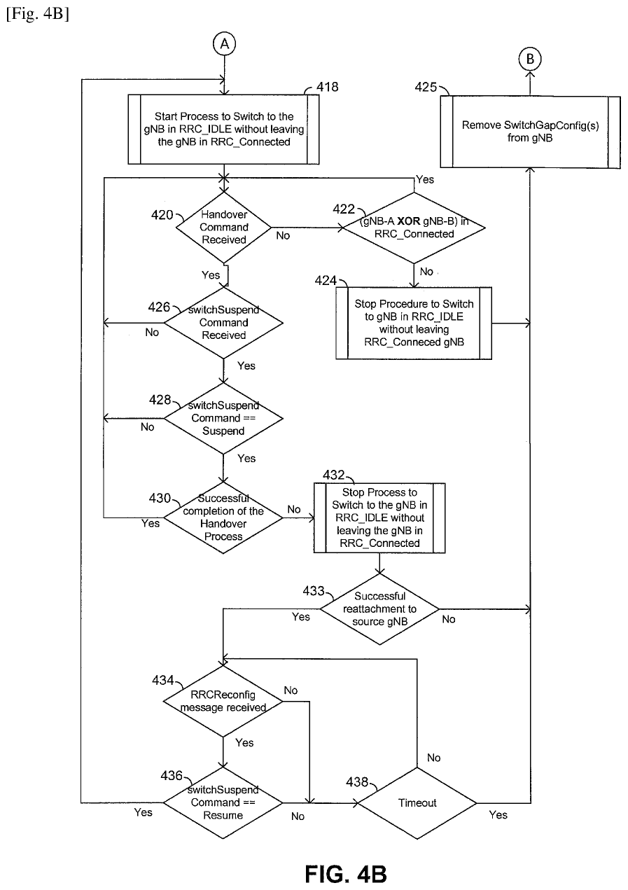

FIGS. 4A and 4B illustrate a flow diagram of a method 400 performed be a UE to facilitate a suspension of a gap switching procedure after a failure of a handover procedure, according to an example implementation of the present disclosure. In some implementations, fewer than all of the operations depicted in FIGS. 4A and/or 4B may be executed. Also, in some implementations, some of the operations in FIG. 4 may be executed in association with each handover, while some of the operations in FIGS. 4A and/or 4B may be executed less often than with each handover. Other methods described below may be similarly modified in some implementations. Also, for methods that span more than one drawing, corresponding connections between drawings are marked by way of a circle with an enclosed letter (e.g., “A”, “B”, and so forth).

In method 400, at operation 402 of FIG. 4A, a determination may be made as to whether the UE is configured with MUSIM (e.g., dual USIM) capability. If not configured with MUSIM (e.g., dual USIM) capability, then method 400 may end. Otherwise, the method 400 may proceed to operation 404.

Collectively, operations 404 and 408 may confirm whether various conditions of the UE have been met before proceeding to the remainder of method 400. For example, at operation 404, a determination may be made as to whether both USIM-A and USIM-B are enabled (e.g., in a state in which both USIM-A and USIM-B each may be used to access an associated network). If either USIM-A or USIM-B, or both, are disabled, method 400 may continue to execute operation 404 until both USIM-A and USIM-B are enabled. At operation 408, a determination may be made as to whether the UE has established a connected state (e.g., RRC_CONNECTED) with a base station of a network associated with either USIM-A (e.g., referred to in FIG. 4 as gNB-A) or USIM-B (e.g., referred to in FIG. 4 as gNB-B), but not both (e.g., as indicated by the exclusive-OR (“XOR”) operation depicted in operation 408 of FIG. 4). If the UE has established a connected state with a gNB of a network associated with either USIM-A or USIM-B, but not both, then the UE may proceed to operation 410. For example, the UE may be in an RRC_CONNECTED state with gNB-A and in an RRC_IDLE state with gNB-B, or vice versa. Otherwise, method 400 may return to operation 404.

At operation 410, the UE may obtain system timing information from the gNB with which the UE is in an RRC_IDLE state. In some implementations, the system timing information may include the frame structure, system timing, and/or system configuration information (e.g., based on the UE's reception of one or more of PSS, SSS, MIB, SIB1, or SIB2 messages broadcast by the gNB in the RRC_IDLE state with the UE). At operation 412, the UE may determine a set of gap parameters (e.g., parameters, such as those specified in a switchGapConfig IE, sufficient to identify and request one or more time intervals or periods during which UL and DL time and frequency resources for the UE are not to be scheduled by a gNB with which the UE is in an RRC_CONNECTED state) from the obtained system timing information.

At operation 414, the UE may generate and transmit a request to the gNB with which the UE is in the RRC_CONNECTED state for one or more switch gap configurations based on the gap parameters. At operation 416, the UE, in response to the previously transmitted request, may receive the requested one or more switch gap configurations from the gNB with which the UE is in the RRC_CONNECTED state and then proceed to operation 418 of FIG. 4B. In some implementations, if the UE does not receive the requested switch gap configurations, method 400 may end, or may return to operation 404.

In method 400 of FIG. 4B, at operation 418, the UE may initiate a switching procedure that determines opportunities for the UE to switch to the gNB with which the UE is in the RRC_IDLE state, based on the received one or more switch gap con-figurations, without leaving the gNB with which the UE is in the RRC_CONNECTED state.

At operation 420, the UE may determine whether a handover command has been received (e.g., while the switching procedure of operation 418 is operating). If a handover command has not been received, the UE may proceed to operation 422. At operation 422, if the UE is in an RRC_CONNECTED state with either gNB-A or gNB-B, but not both (e.g., in a manner similar to operation 408), the UE may continue to wait for a handover command at operation 420 (e.g., while the switching procedure of operation 418 continues). Otherwise, the UE may proceed to operation 424, where the UE may stop the ongoing switching procedure, and to operation 425, where the UE may remove or cancel the switch gap configurations (e.g., from the gNB with which the UE was in an RRC_CONNECTED state), at which point method 400 may terminate.

If, instead, at operation 420, the handover command has been received, the UE may proceed to operation 426. At operation 426, the UE may determine whether the message that transported the handover command to the UE also transported a switchSuspendCommand. If the message did not include a switchSuspendCommand command, the UE may return to operation 420 and may continue the switching procedure to switch to the gNB with which the UE is in the RRC_IDLE state (e.g., without leaving the gNB with which the UE is in the RRC_CONNECTED state). If, instead, the message includes a switchSuspendCommand command, the UE may proceed to operation 428. At operation 428, the UE may determine whether the switchSuspendCommand has a value indicating suspension of the switching procedure (e.g., a value of Suspend). If the switchSuspendCommand does not have a value of Suspend, (e.g., has a value of Resume) the UE may return to operation 420 and may continue the switching procedure to switch to the gNB with which the UE is in the RRC_IDLE state (e.g., without leaving the gNB with which the UE is in the RRC_CONNECTED state).

If the switchSuspendCommand has a value of Suspend (at operation 428), the UE may proceed to operation 430. At operation 430, the UE may await completion of the handover procedure, at which time the UE may proceed to operation 420, at which the UE may await another handover command. In some implementations, if, instead, a failure of the handover procedure from a source gNB (e.g., the gNB with which the UE was in an RRC_CONNECTED state) is detected at operation 430, the UE may proceed from operation 430 to operation 432. At operation 432, the UE may suspend or pause the switching process (e.g., to the gNB with which the UE is in the RRC_IDLE state).

At operation 433, the UE may determine if an attempted reestablishment of the connection of the UE with the source gNB was successful. If so, the UE may proceed to operation 434. Otherwise, the UE may proceed to operation 425, in which the UE may remove or cancel the switch gap configurations (e.g., from the gNB with which the UE was in an RRC_CONNECTED state), at which point the process may terminate.

At operation 434, the UE may determine whether an RRCConfiguration message (or a MAC-CE message) has been received. If the UE has not received such a message, the UE may proceed to operation 438, where the UE may then determine whether a timeout (e.g., by way of a running timer) has occurred since the suspension of the switching process at operation 432. If a timeout has not occurred, the UE may then return to operation 434. Otherwise, if a timeout has occurred, the UE may proceed to operation 425, in which the UE may remove or cancel the switch gap configurations (e.g., from the gNB with which the UE was in an RRC_CONNECTED state), at which point the process may terminate.

In some implementations, if the UE receives an RRCReconfiguration (or MAC-CE) message at operation 434, the UE may proceed to operation 436. At operation 436, the UE may determine whether the message includes a switchSuspendCommand with a value of Resume. If the message includes a switchSuspendCommand with a value of Resume, the UE may return to operation 418, at which the UE may, once again, start the switching process based on the current at least one switch gap configuration without leaving the gNB with which the UE is now in an RRC_CONNECTED state. Otherwise, if the message does not include a switchSuspendCommand with a value of Resume, the UE may proceed to operation 438, where the UE may determine whether a timeout has occurred, as discussed above.

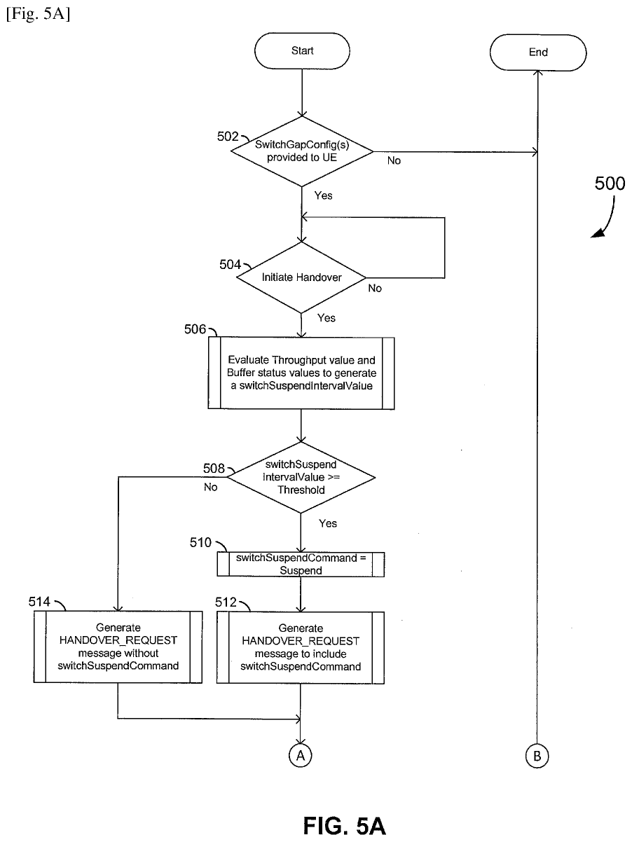

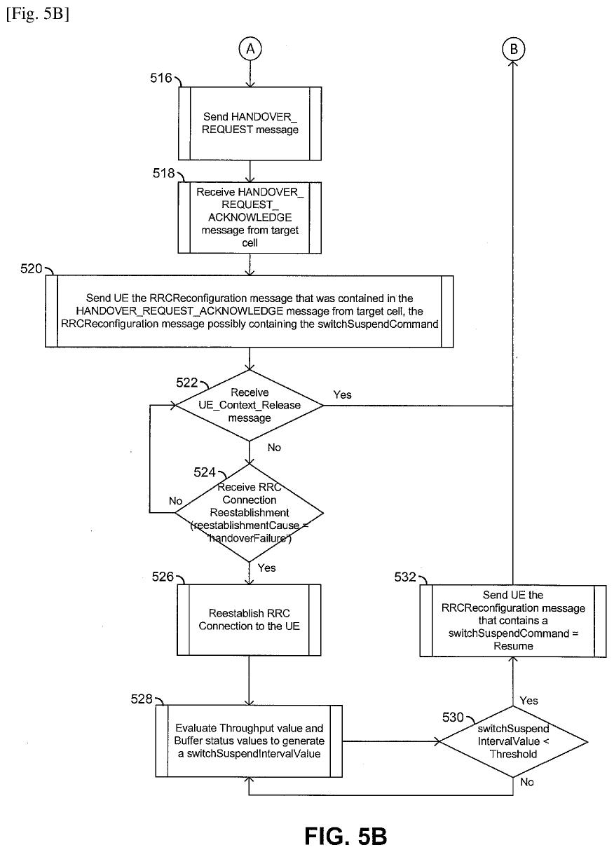

FIGS. 5A and 5B illustrate a flow diagram of a method 500 performed by a source gNB to facilitate a suspension of a switching procedure after a failure of a handover procedure, according to an example implementation of the present disclosure. In method 500, at operation 502, the source gNB may determine whether the source gNB has provided one or more switch gap configurations to the UE. If not, method 500 may end. Otherwise, method 500 may proceed to operation 504. At operation 504, the source gNB may determine whether a handover operation of the UE to a target gNB should be performed. If not, the source gNB may make the same determination (e.g., repeatedly) until such a handover is to be initiated, at which point method 500 may proceed to operation 506.

At operation 506, the source gNB may evaluate one or more types of information to generate a possible suspension interval value (e.g., a timer value, such as a switchSuspendIntervalValue) during which the UE may be instructed to suspend or pause the switching procedure being used by the UE (e.g., in accordance with the one or more switch gap configurations) after a failure of the handover procedure. Such information may include, but is not limited to, one or more of a value indicating the UL/DL data throughput between the UE and the source gNB, a value indicating an amount of DL data intended for the UE that is buffered at the source gNB, and/or a value indicating an amount of UL data intended for the source gNB that is buffered at the UE.

At operation 508, the source gNB may then compare the generated suspension interval value to a threshold value. If the generated suspension interval value is greater than or equal to the threshold, the source gNB may proceed to operation 510. At operation 510, the source gNB may generate a switchSuspendCommand with a value of Suspend. Thereafter, at operation 512, the source gNB may generate a HANDOVER_REQUEST message that includes the generated switchSuspendCommand. Instead, if the generated suspension interval value at operation 508 is less than the threshold, the source gNB may proceed to operation 514, at which the source gNB may generate a HANDOVER_REQUEST message that does not include a switchSuspendCommand. Alternately, at operation 514, in some implementations, the target gNB may generate a HANDOVER_REQUEST message that includes a switchSuspendCommand with a value of Resume. Further, from operation 512 or 514, the source gNB may proceed to operation 516 of FIG. 5B, at which the source gNB may transmit, to the target gNB, the HANDOVER-REQUEST message. Thereafter, at operation 518, in response to the HANDOVER-REQUEST message, the source gNB may receive a HANDOVER-REQUEST-ACKNOWLEDGE message from the target gNB that includes an RRCReconfiguration message generated by the target gNB. Subsequently, at operation 520, the source gNB may transmit, to the UE, the RRCReconfiguration message to initiate the handover operation, and then proceed to operation 522. In some implementations, the RRCReconfiguration message may include a switchSuspendCommand that was originally generated by the source gNB at operation 510.

In some implementations, subsequent to operation 520, after transmitting an RRCReconfiguration message that includes a switchSuspendCommand with a value of Suspend, the source gNB may await reception of either a UE_Context_Release message (at operation 522), indicating that the handover procedure of the UE to the target gNB was successfully completed, or an RRC Connection Reestablishment message (e.g., with reestablishmentCause=‘handoverFailure’) (at operation 524), indicating that the handover procedure failed, and that the UE is attempting to reconnect with the source gNB. If the UE_Context_Release message is received at operation 522, the source gNB may terminate the method. Otherwise, if the RRC Connection Reestablishment message is received, the source gNB may proceed to operation 526 to reestablish the RRC connection to the UE.

The source gNB may then proceed to operations 528 and 530 to repeatedly or repetitively evaluate the throughput and/or buffer status values described above to generate a switchSuspendIntervalValue (e.g., in a manner similar to operation 506) and compare the value to a threshold (e.g., in a manner similar to operation 508). At operation 530, if the switchSuspendIntervalValue is greater than or equal to the threshold, the source gNB may return to operation 528 to perform the evaluation again. Otherwise, if the switchSuspendIntervalValue is less than the threshold, the source gNB may transmit, to the UE, an RRCReconfiguration message that includes a switchSuspendCommand with a value of Resume, thus allowing the UE to resume the use of the switch gap configuration to resume the switching process described above.

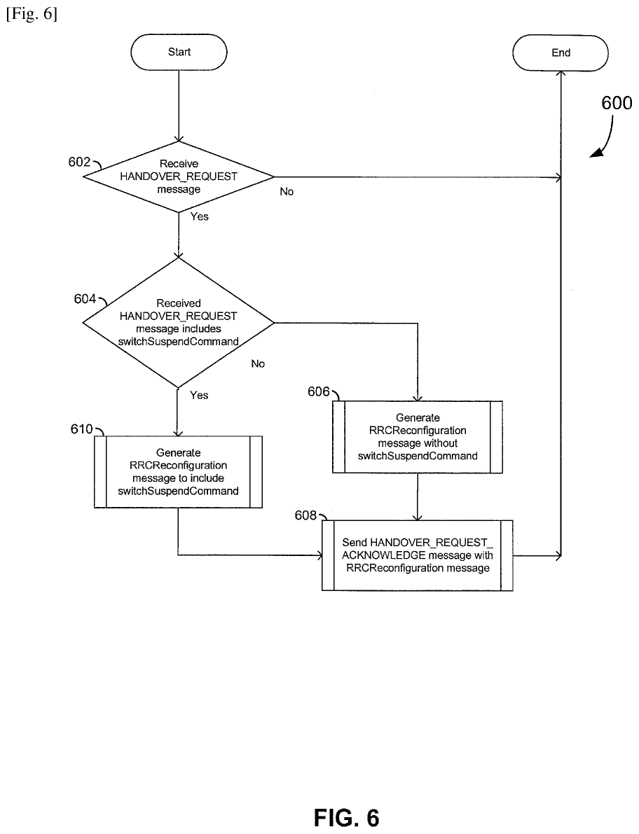

FIG. 6 illustrates a flow diagram of a method 600 performed by a target gNB to facilitate a suspension of a switching procedure after a failure of a handover procedure, according to an example implementation of the present disclosure. In method 600, at operation 602, the target gNB may receive, from a source gNB, a HANDOVER-REQUEST message to hand over a UE. At operation 604, the target gNB may then determine whether the received HANDOVER-REQUEST message includes a switchSuspendCommand. If so, the target gNB may proceed to operation 610, at which point the target gNB may generate an RRCReconfiguration message that includes the received switchSuspendCommand. Otherwise, if the received HANDOVER-REQUEST message does not include a switchSuspendCommand, the target gNB may proceed to operation 606, at which point the target gNB may generate an RRCReconfiguration message without an accompanying switchSuspendCommand. From operation 606 or 610, the target gNB may transmit, to the source gNB, at operation 608, a HANDOVER-REQUEST-ACKNOWLEDGE message that includes the generated RRCReconfiguration message, after which the process may terminate.

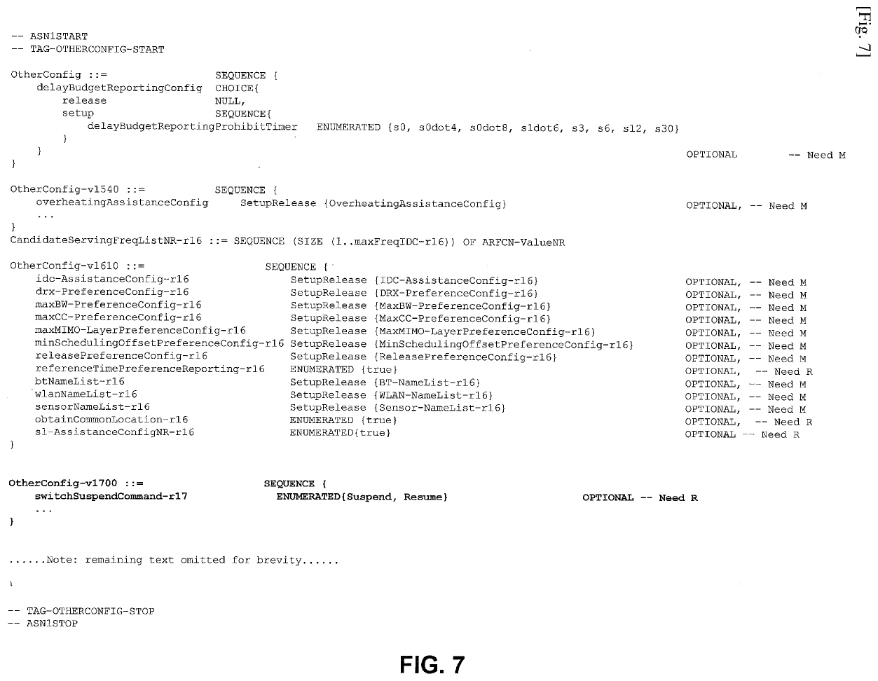

FIG. 7 illustrates an example of a new Other Configuration (otherConfig) information element (IE), according to an example implementation of the present disclosure. As depicted in FIG. 7, the otherConfig IE may include a new command, switchSuspendCommand (indicated in bold font in FIG. 7 as switchSuspendCommand-r17). In some implementations, the otherConfig IE is intended to be carried by the RRCReconfiguration message for triggering a handover of the UE from a source gNB of a first network to the target gNB of the first network. As described above, the switchSuspendCommand, when transmitted from the source gNB to the UE, may enable the switching procedure of the UE to be paused or suspended (e.g., in-definitely until subsequently resumed), as indicated by switchSuspendCommand having an enumerated value of Suspend following the reestablishment of the connection between the source gNB and the UE after a failure of the handover procedure. In other examples, the switchSuspendCommand, when transmitted from the source gNB to the UE, may resume a previously suspended switching procedure of the UE, or may cause an ongoing switching procedure to continue, as indicated by switchSuspendCommand having an enumerated value of Resume. As discussed above, the switching procedure may include use of the currently-jointly-in-use one or more switch gap configurations to determine opportunities when the UE may Switch Without Leaving the source gNB to receive paging and other information from a gNB of a second network. In some implementations, the switchSuspendCommand may be defined within the otherConfig IE as an enumerated value of Suspend or Resume that configures the UE to control the Switching Process. A value of Suspend, in some implementations, may mean that the UE is to suspend the Switching Process immediately following the reestablishment of the connection between the source gNB and the UE after a failure of the handover procedure. In some such implementations, a value of Resume may mean that the UE is to resume the Switching Process.

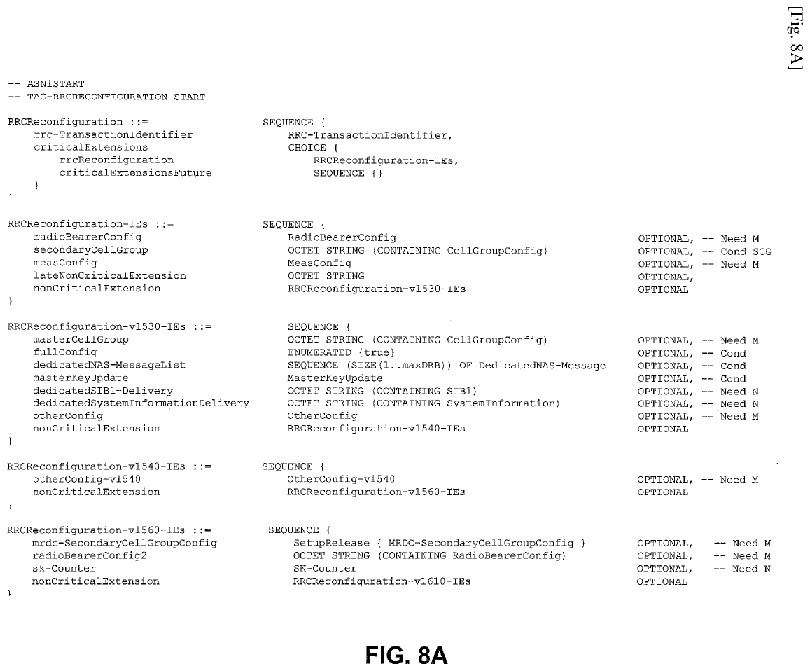

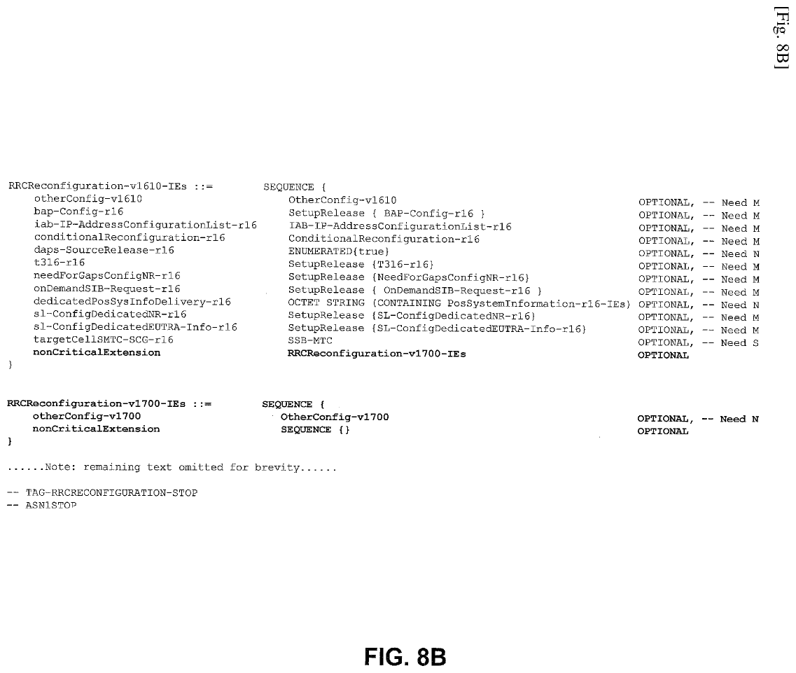

FIGS. 8A and 8B illustrate an example of a new RRC Reconfiguration (RRCReconfiguration) IE, according to an example implementation of the present application. In some implementations, the new RRCReconfiguration IE that includes the switchSuspendCommand via the new otherConfig IE, as indicated in FIG. 7, is illustrated in bold font in FIG. 8B. Generally, the RRCReconfiguration message may modify an RRC connection. In some implementations, the RRCReconfiguration message may convey information for measurement configuration, mobility control, radio resource configuration (e.g., including Resource Blocks (RBs), Media Access Control (MAC) main configuration, and physical (PHY) channel configuration), Access Stratum (AS) security configuration, and so on.

The following example describes what operations the NR UE may perform upon reception of an RRCReconfiguration message with an otherConfig message that includes a new IE switchSuspendCommand-r17, as an addition to the existing text in the 3GPP TS 38.331 (e.g., at Sections 5.3.5.3 and 5.3.5.9, with reference to Conditional Handover (CHO) and Conditional Primary Secondary Cell (PSCell) Change (CPC)):
5.3.5.3 Upon receiving of the RRCReconfiguration, or upon execution of the conditional reconfiguration (CHO or CPC):
   1> if the RRCReconfiguration is applied due to a conditional reconfiguration execution upon cell selection performed while timer T311 was running, as defined in 5.3.7.3:
      2> remove all the entries within VarConditionalReconfig, if any; ( . . . Text removed for brevity . . . )
   1> if the RRCReconfiguration message includes the otherConfig:
      2> perform the other configuration procedure as specified in 5.3.5.9; ( . . . Remaining text of 5.3.5.3 removed for brevity . . . )
5.3.5.9 Other configuration
The UE shall:
   1> if the received otherConfig includes the delayBudgetReportingConfig:
      2> if delayBudgetReportingConfig is set to setup:
         3> consider itself to be configured to send delay budget reports in accordance with 5.7.4;
      2> else:
         3> consider itself not to be configured to send delay budget reports and stop timer T342, if running.
   1> if the received otherConfig includes the switchSuspendCommand:
      2> if SwitchSuspendComand is set to Suspend:
         3> consider itself to be configured to suspend the Switch Process immediately after reestablishment of the previous connection after a failure of the handover.
      2> if SwitchSuspendComand is set to Resume:
         3> consider itself to be configured to resume the Switch Process.
   1> else:
      2> consider itself to be configured to not suspend the Switch Process immediately after reestablishment of the previous connection after a failure of the handover;
( . . . Remaining text of 5.3.5.9 removed for brevity . . . )

### CROSS REFERENCE

This Nonprovisional application claims priority under 35 U.S.C. § 119 on provisional Application No. 63/291,930 on Dec. 20, 2021, the entire contents of which are hereby incorporated by reference.

What is claimed is:

1. A user equipment (UE), comprising:
one or more non-transitory computer-readable media having computer-executable instructions embodied thereon; and
at least one processor coupled to the one or more non-transitory computer-readable media and configured to execute the computer-executable instructions to:
while maintaining a Radio Resource Control (RRC) connection with a first base station (BS) of a first network, receive transmissions from a second BS of a second network during at least one time period specified in a switch gap configuration;
receive a first RRC reconfiguration message from the first BS, the first RRC reconfiguration message comprising a first command and a second command,
the first command instructing the UE to begin a handover procedure from the first BS to a third BS, and
the second command controlling usage of the switch gap configuration by the UE following a failure of the handover procedure;
initiate execution of the handover procedure from the first BS to the third BS according to the first command;
determine, after initiating the execution of the handover procedure, that the handover procedure has failed;
reestablish, after determining that the handover procedure has failed, the RRC connection with the first BS; and
when the second command suspends continued usage of the switch gap configuration following the failure of the handover procedure, suspend reception of transmissions from the second BS following reestablishing of the RRC connection with the first BS.

2. The UE of claim 1, wherein the at least one processor is further configured to execute the computer-executable instructions to:
while suspending the reception of transmissions from the second BS, receive a second RRC reconfiguration message from the first BS, the second RRC reconfiguration message comprising a third command to resume the reception of transmissions from the second BS; and
in response to receiving the second RRC reconfiguration message, resume the reception of transmissions from the second BS.

3. The UE of claim 1, wherein the at least one processor is further configured to execute the computer-executable instructions to:
when the second command suspends continued usage of the switch gap configuration following the failure of the handover procedure, initiate a timer; and
if, before receiving the second RRC reconfiguration message, the timer expires, cause the first BS to remove the switch gap configuration.

4. The UE of claim 1, wherein the at least one processor is further configured to execute the computer-executable instructions to:
where the second command disables suspension of the continued usage of the switch gap configuration, continue to receive transmissions from the second BS following reestablishing the RRC connection with the first BS.

5. The UE of claim 1, wherein the first RRC reconfiguration message comprises an RRCReconfiguration message.

6. The UE of claim 5, wherein the second command comprises a switchSuspendCommand contained in the RRCReconfiguration message, the switchSuspendCommand comprising an enumerated value indicating whether to suspend or resume receiving transmissions from the second BS.

7. The UE of claim 6, wherein the RRCReconfiguration message comprises an OtherConfig information element (IE) that includes the switchSuspendCommand.

8. The UE of claim 6, wherein:
the RRCReconfiguration message is generated by the third BS; and
the switchSuspendCommand is generated by the first BS.

9. The UE of claim 1, wherein the at least one processor is further configured to execute the computer-executable instructions to:
receive an RRCReconfiguration message comprising a switchGapConfig IE that includes the switch gap configuration.

10. A first base station (BS) of a first network, the first BS comprising:
one or more non-transitory computer-readable media having computer-executable instructions embodied thereon; and
at least one processor coupled to the one or more non-transitory computer-readable media and configured to execute the computer-executable instructions to:
maintain a Radio Resource Control (RRC) connection with a user equipment (UE) while facilitating gaps in communication with the UE according to a switch gap configuration to facilitate reception of transmissions by the UE from a second BS of a second network; and
transmit, to the UE, an RRC reconfiguration message comprising a first command and a second command,
the first command instructing the UE to begin a handover procedure from the first BS to a third BS, and
the second command comprising a value indicating whether usage of the switch gap configuration by the UE is to be suspended following a failure of the handover procedure.

11. The first BS of claim 10, the at least one processor further configured to execute the computer-executable instructions to:
transmit, to the third BS, a handover request message comprising the second command; and
receive, from the third BS in response to the handover request message, a handover request acknowledgment message comprising the first command and the second command.

12. The first BS of claim 11, wherein the handover request acknowledgment message comprises an RRCReconfiguration message that includes the first command and the second command.

13. The first BS of claim 12, wherein:
the second command comprises a switchSuspendCommand; and
the RRCReconfiguration message comprises an OtherConfig information element (IE) that includes the switchSuspendCommand.

14. A first base station (BS), the first BS comprising:
one or more non-transitory computer-readable media having computer-executable instructions embodied thereon; and
at least one processor coupled to the one or more non-transitory computer-readable media and configured to execute the computer-executable instructions to:
receive, from a second BS of a first network, a handover request message for a user equipment (UE), the handover request message comprising a first command indicating whether usage of a switch gap configuration by the UE is to be suspended following a failure of a handover procedure, the switch gap configuration specifying at least one time period during which the UE receives transmissions from a third BS of a second network;
generate an RRC reconfiguration message comprising the first command and a second command, the second command instructing the UE to begin a handover procedure from the second BS to the first BS;
and
transmit, to the second BS, a handover request acknowledgment message comprising the RRC reconfiguration message.

15. The first BS of claim 14, wherein:
the first command comprises a switchSuspendCommand; and
the handover request acknowledgment message comprises an RRCRe-configuration message that includes an OtherConfig information element (IE) comprising the switchSuspendCommand.
